(19) United States
(12) Patent Application Publication
(10) Pub. No.: US 2015/0241577 A1
(43) Pub. Date: Aug. 27, 2015

(54) Combined Epithermal And Thermal Neutron Detector And Its Application To Well Logging Instruments

(71) Applicant: Schlumberger Technology Corporation, Sugar Land, TX (US)

(72) Inventors: Timothy Spillane, Quincy, MA (US); Zilu Zhou, Needham, MA (US); Markus Berheide, Medford, MA (US); Bradley Roscoe, West Chesterfield, NH (US)

(21) Appl. No.: 14/571,604

(22) Filed: Dec. 16, 2014

Related U.S. Application Data
(60) Provisional application No. 61/918,368, filed on Dec. 19, 2013.

(51) Int. Cl. G01T 3/00; G01V 5/10; G01T 3/06

(52) U.S. Cl. CPC G01T 3/00; G01T 3/06; G01T 3/008; G01V 5/107

(57) ABSTRACT

A combined thermal neutron and epithermal neutron radiation detector includes a plurality of neutron detecting elements arranged such that a first set of the detecting elements is disposed closer to a source of neutron flux scatted from a material or formation to be analyzed than a second set of detecting elements. The neutron detecting elements have a material therein susceptible to capture of thermal neutrons for detection. Signal outputs of the first set of are interconnected and signal outputs of the second set are separately interconnected to provide a signal output corresponding to each of thermal neutron flux and epithermal neutron flux entering the detector.

### CROSS-REFERENCE TO RELATED APPLICATIONS

This application claims benefit of U.S. Provisional Patent Application Ser. No. 61/918,368, filed Dec. 19, 2013, which is herein incorporated by reference.

### STATEMENT REGARDING FEDERALLY SPONSORED RESEARCH OR DEVELOPMENT

Not applicable.

### BACKGROUND

This disclosure relates generally to the field of neutron radiation detectors. More specifically, the invention relates to neutron detectors that can detect both epithermal and thermal neutrons and identify such detections accordingly.

Neutron well logging instruments are used to infer subsurface formation parameters from the flux of neutrons from a high energy neutron source in the instrument which have scattered from the formation back into one or more detectors in the instrument, wherein neutron or gamma ray detectors may be disposed at one or more locations within the instrument and axially spaced apart from the neutron source. The distribution of neutrons about the source in both space and energy is strongly dependent upon the hydrogen content and elemental neutron absorber content of formations and fluid in the borehole through which the instrument is conveyed to make such measurements. For example, a typical neutron porosity tool uses a set of neutron detectors to characterize the spatial distribution of thermal or epithermal neutrons, from which the porosity of the formation is derived. Neutrons may be produced by an electrically operated accelerator source (for example d-T or d-D) or radioisotope source at fairly high energies (for example AmBe or Cf), corresponding to 14 (or 2.5 with d-D) MeV or 0-7 MeV range, respectively. Through interactions with the surroundings, primarily with hydrogen, the neutrons transfer energy as they diffuse from the source, until eventually they reach equilibrium with the thermal energy of the formation. Thus a measurement of the neutron flux at some distance from the source and at some energy well below the neutron source energy is a measure of the degree of neutron energy moderation, which in turn is in good approximation a measure of the hydrogen content mostly in fluids (e.g. water, oil and gas) situated in porous space, a proxy for formation porosity. In addition to porosity, neutron-neutron tools may measure parameters (or in turn may require corrections) related to borehole and/or formation sigma (neutron absorption cross-section) and formation hydrogen index, specifically when using a pulsed, electrically operated neutron source.

Neutron flux measurements of both thermal neutrons (neutrons with energies less than about 0.1 eV) and epithermal neutrons (in a range of about 0.4 eV to 10 eV) have been used in “neutron-neutron” instruments, i.e., instruments which have a neutron source and one or more neutron detectors. Both neutron detection energy ranges have benefits and drawbacks as it concerns evaluation of subsurface formations. For example, thermal neutrons are detectable with higher efficiency than epithermal neutrons. However, the detected flux may be affected by thermal neutron absorbers in the formations and in the wellbore (e.g., chlorine) necessitating larger corrections in the interpretation of thermal neutron flux measurements to obtain neutron porosity compared to epithermal measurements. The high efficiency of thermal measurements provide high counting rates, which reduces statistical variation in the measurements, whereas the smaller corrections needed for an epithermal measurement may increase accuracy.

Proportional neutron counters, and in particular helium-3 (³He) gas tubes, are known in the art for detecting neutrons in a well logging instrument. A ³He detector consists of a cylindrical tube filled with ³He gas at a predetermined pressure. A single anode wire runs down the middle of the tube. The anode wire serves the dual purposes of creating a Townsend “avalanche” to amplify the signal from a captured neutron, and collecting the resulting amplified signal. The neutron sensitive material in the ³He tube is the ³He gas itself. Other detectors may use boron trifluouride (BF₃) gas for the same purpose. In order to detect a particular energy range of neutron, neutron detectors are purposely built, typically by shrouding the detector in a filter (typically a layer of Cadmium) which enables only neutrons above a certain energy level to pass through. The filter is typically applied on the outside of the tube, as any additional material on the inside of the tube may interfere with the proper operation of the detector.

The neutron capture cross-section of ³He (and also of alternatives such as lithium-6, and boron-10) increases rapidly as the neutron energy decreases, and the detection probability depends in turn on the cross-section. Thus, in a typical wellbore environment where neutrons of a wide range of energies are incident on a neutron detector, the detector count rate will be dominated by thermal neutrons. In this manner a bare ³He tube (i.e., without a thermal neutron filter) is for all practical purposes a thermal neutron detector. In order to create a detector sensitive to epithermal neutrons the ³He tube may wrapped in a filter layer which captures thermal neutrons, but allows more energetic neutrons to pass through; consequently epithermal neutrons are preferentially detected. Typically the filtering of thermal neutrons is achieved with a cadmium wrap of a few hundredths of an inch thick.

³He gas used in these detectors has become scarce. This has led to efforts to identify and engineer different materials and structures for neutron detectors. One such neutron detector design uses layers of boron-10 covered cathodes within a gas pressure vessel. In this detector high efficiency is achieved by efficient packing of the thin (micrometer range thickness) boron-10 covered cathodes, rather than using high ³He gas density (pressure). Such detectors in various forms may be commercially available.

An example of a neutron detector using this approach is described here. For shortness it is referred to as the Compact Proportional Counter (CPC). The CPC uses flat or specially shaped electrically conductive cathodes with a boron-10 (¹⁰B) enriched conversion layer, ˜1 μm thick, deposited on the surface thereof. The ¹⁰B layer is separated by a small gas gap (ranging from ˜0.5 mm to a few mm thickness) from an anode layer consisting of thin metallic traces printed on a non-conductive substrate. The fill gas can be for example argon mixed with methane, or any other combination of gases commonly used in proportional counters. Stacks of this basic structure are used to maximize the neutron sensitivity. Like ³He, ¹⁰B has a high neutron capture cross-section, thus high neutron detection efficiency can be achieved. However, due to its solid form and relatively high density, ¹⁰B metal or ¹⁰B carbide has a significantly high stopping power per unit thickness to limit the secondary charged particles from the neutron reaction to emit into the gas region for detection. Therefore, careful design and layering is required to mitigate this so-called wall effects.

A conceptually similar approach called Boron Coated Straws (BCS) has been developed. BCS uses hollow cylindrical tubes or “straws” a few millimeters in diameter with an interior wall of each cylindrical straw lined with a thin layer of boron-10. A thin anode wire is substantially centered within the cylindrical straw, serving the same purpose as the anode wire in a conventional ³He counter. High neutron stopping power may be attained by bundling many of these straws together into a structure of selected shape. See, for example, Jeffrey L. Lacy, et al., Boron-Coated Straws as a Replacement for ³He-based Neutron Detectors, Nucl. Instru. & Methods A, Vol. 652, Issue 1, 1 Oct. 2011, Pages 359-363

While CPC and BCS structures feature a number of anodes corresponding to the number of detecting elements, each carrying the signal from a discrete volume of the detector, the anodes are typically electrically connected together such that the resulting signal represents the sum of neutron detection throughout the detector volume.

For the purpose of assessing the hydrogen content of a formation using a wellbore disposed neutron well logging instrument, the detection of epithermal neutrons may be more desirable than detecting thermal detection. Detecting epithermal neutrons may minimize or avoid the effects of thermal neutron absorbers in the formation and wellbore. However, the epithermal neutron detection rate drops substantially as function of neutron energy for a number of reasons. First, potential neutron flux for detection with higher energies is low, and second, higher energy neutrons are detected with lower efficiency. Thus, an epithermal neutron well logging instrument has been proven challenging to be built with a radioisotope source, wherein the source flux is limited and the source neutron energy is relatively low, resulting in relatively poor statistical precision, notwithstanding the accuracy advantages of epithermal neutron detection. The foregoing challenges may be overcome using pulsed, electrically operated neutron sources known in the art.

A combination of both types of individual detector in a single tool as illustrated in FIGS. 1 and 2 provides the advantage of both thermal neutron and epithermal neutron measurements, and allows for correcting the more precise data by using more accurate data. The configurations shown in FIGS. 1 and 2 may be challenging in practice due to space limitations in the tool. Compromises between both types of neutron detectors in source-detector spacing and compromises between neutron and gamma-ray detectors have to be made in order to accommodate multi-physics measurements. Examples of such prior art instruments are shown in FIGS. 1 and 2.

### SUMMARY

A combined thermal neutron and epithermal neutron radiation detector according to one aspect includes a plurality of neutron detecting elements arranged such that a first set of the detecting elements is disposed closer to a source of neutron flux scatted from a material or formation to be analyzed than a second set of detecting elements. The neutron detecting elements have a material therein susceptible to capture of thermal neutrons for detection. Signal outputs of the first set of detecting elements are interconnected and signal outputs of the second set are separately interconnected to provide a signal output corresponding to each of thermal neutron flux and epithermal neutron flux entering the detector.

Other aspects and advantages will be apparent from the description and claims that follow.

### BRIEF DESCRIPTION OF THE DRAWINGS

FIG. 1 shows an example of a well logging instrument having both individual thermal neutron detectors and epithermal neutron detectors.

FIG. 2 shows an example of a well logging instrument having individual thermal neutron detectors, epithermal neutron detectors and spectral gamma ray detectors.

FIG. 3A shows an example neutron well logging instrument using two combined thermal neutron/epithermal neutron detectors according to the present disclosure.

FIG. 3B shows a cross-section of a combined detector as may be used in a well logging instrument such as shown in FIG. 3A where the instrument is configured to be urged against a wall of a wellbore.

FIG. 4A and FIG. 4B show, respectively, a graph of and a histogram map of simulated neutron count rates with respect to position within a helium-3 proportional counter.

FIG. 5A and FIG. 5B, show, respectively, a graph and a histogram map of simulated epithermal neutron count rates in a counter such as used for the simulation of FIGS. 4A and 4B.

FIG. 6A and FIG. 6B show, respectively, a graph and a histogram map of thermal neutron count rates with respect to position within a compact proportional counter with ˜1 mm size elements and 1 μm boron-10 layers wherein a thermal neutron filter is disposed within the neutron counter.

FIGS. 6C and 6D show, respectively, similar views as FIGS. 6A and 6B, but for epithermal neutrons at a lower end of the epithermal neutron energy range.

FIGS. 6E and 6F show, respectively, similar view as FIGS. 6A and 6B, but for epithermal neutrons at an upper end of the epithermal neutron energy range.

FIGS. 7A through 7D show various configurations of the cathodes of a compact proportional neutron counter.

FIG. 8 shows an example configuration of a combination neutron detector.

FIGS. 9A through 9D show various configurations of a directionally sensitive combination neutron detector.

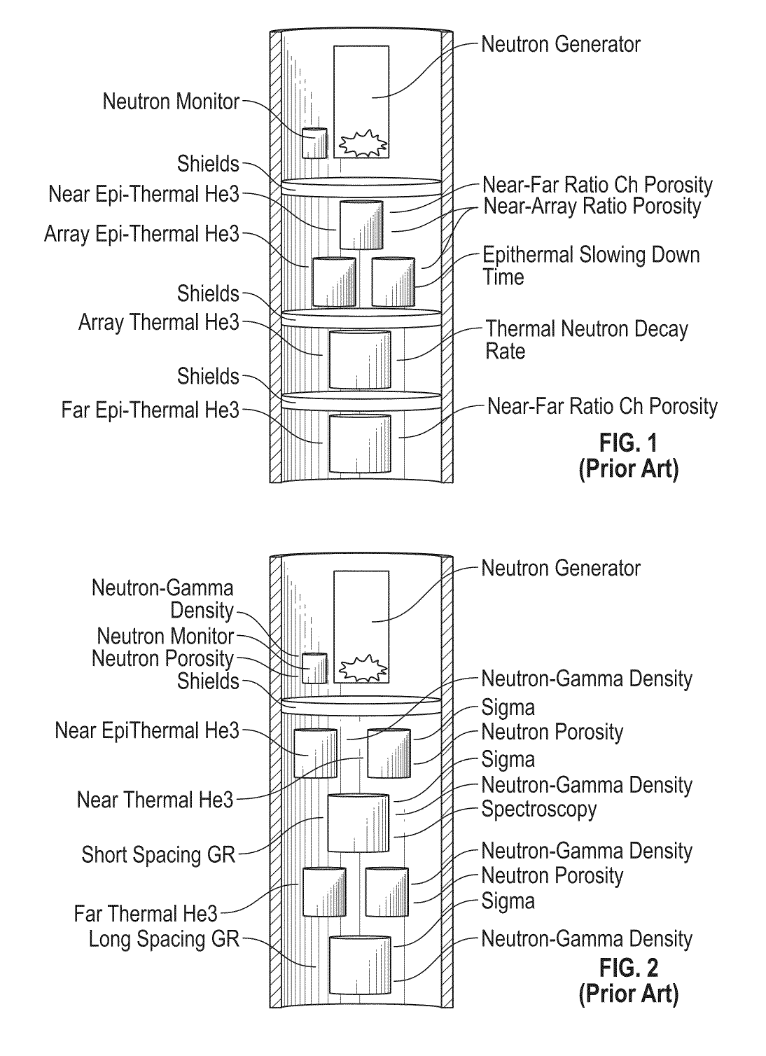

### DETAILED DESCRIPTION

The fundamental structure of a combined thermal neutron and epithermal neutron detector neuron detector according to the present disclosure is a single detector assembly having the capability to measure both thermal and epithermal neutrons separately and simultaneously. The neutron capture cross sections of the sensitive materials in the detectors mentioned above in the Background section herein are similar in that they decrease rapidly as the neutron energy increases. This means that if one had an infinitely thick detector, it could be divided into sections by depth from its external surface, with low energy (thermal) neutron detection signals dominating the outermost section closest to the outer surface, and neutrons of increasing energy as the detected signal at increasing depth into the detector from the outer surface. This effect, which will be referred to as “self-shielding”, can be used to create a single detector capable of separately detecting both thermal and epithermal neutrons. The detector structure can be shown to work if it is possible to show the functionality of a detector design that is amenable to the separation of signals from different depths in the detector structure with respect to the neutron flux, and that delivers sufficient thermal neutron absorbing power closer to its exterior surface to fully filter thermal neutrons within a portion of its volume. The latter functionality may be further enhanced by using a physically embodied thermal neutron filter in the detector structure in addition to the self-shielding effect provided by the detector structure thus allowing for relatively small combined thermal and epithermal detectors.

Another concept according to the present disclosure is that the combined thermal and epithermal neutron detector can be optimized with a particular shape suitable for directional neutron flux detection in a well logging instrument. This principle may apply to any neutron well logging instrument where the detectors are preferably eccentered with respect to the instrument axis and/or where the detector is back-shielded. Such configuration may be used in practical implementations of a neutron well logging instrument according to the present disclosure. In the case of a gas-filled proportional detector the combination thermal neutron and epithermal neutron detector may be disposed in (but not limited to) one common pressure housing for the gas fill, while sections of the detector may be covered with a thermal neutron shield, e.g., a cadmium foil layer. Optionally, multiple pressure housing can be deployed for the purpose, even with convenience, which however may not be space and cost effectively.

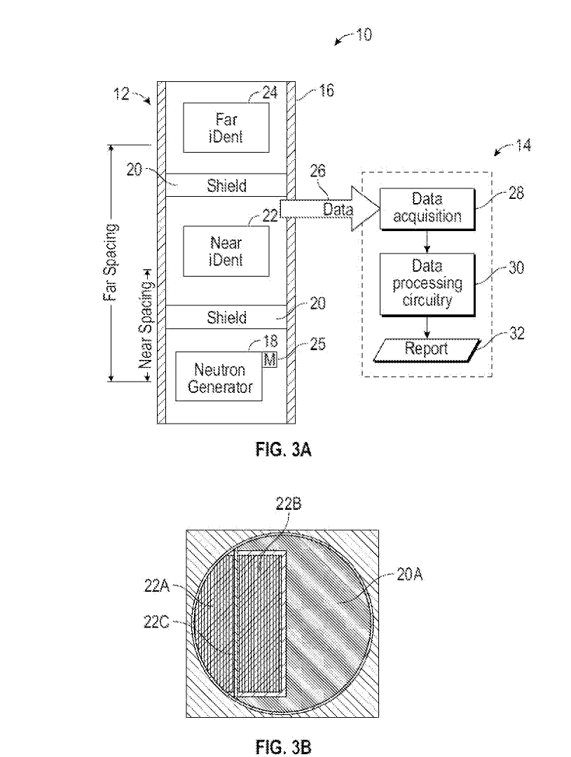

An example implementation of a neutron well logging instrument having combined thermal neutron and epithermal neutron detectors is shown schematically in FIG. 3A. The well logging instrument 10 may be contained within a pressure resistant housing 12 configured to move along the interior of a wellbore. The housing 12 may be made from a high strength material 16 that is relatively transparent to neutrons. The housing 12 may have contained therein a neutron generator 18, for example one as described in U.S. Pat. No. 5,293,410 issued to Chen et al. A neutron monitor detector 25 may be disposed proximate the neutron generator 18 to provide a signal corresponding to the actual neutron output of the neutron generator 18. The signal from the optional neutron monitor 25 may be used to normalize signals detected by a near combination neutron detector 22 spaced at a first axial distance from the neutron generator 18 and a far combination neutron detector 24 disposed in the housing 12 at a second, larger axial distance from the neutron generator 18. Signals from the detectors 22, 24 may be communicated as data 26 to a recording system 14 disposed at the surface. The recording system 14 may include a telemetry decoding system 28 for acquiring the data 26 transmitted by the logging instrument 10, and a data processing system 30 for analyzing the decoded signals from the acquisition system 28. The analyzed data may be communicated to any form of display and/or recording device 32. Measurements of thermal neutron detection rate and epithermal neutron detection rate at each of the detectors 22, 24 may be used in any manner known in the art for analysis of neutron flux at various longitudinal spacings from the neutron generator 18. Shielding 20 may be provided between the neutron generator 18 and the near detector 22 and between the near detector 22 and the far detector 24 to reduce effects of neutrons moving axially along the interior of the instrument 10 as will be appreciated by those skilled in the art.

FIG. 3B shows one example of a combined thermal neutron/epithermal neutron detector (“combined detector”), e.g., the near detector (22 in FIG. 3A) according to the present disclosure. The combined detector 22 shown in FIG. 3B may be configured to be laterally displaced inside the housing (12 in FIG. 3A) so that it is sensitive to neutrons entering the tool housing 12 primarily from one side. In such examples, the housing (12 in FIG. 3A) may be urged against the wall of a wellbore using any biasing device (not shown) known in the art for such purpose. The combined detector 22 may have thermal neutron absorbing material 20A disposed on a side thereof opposed to the side of the combination detector 22 urged toward the wellbore wall. A non-limiting example of such material comprises B₄C in a matrix where the boron may be natural boron or may be enriched in boron-10. The combination detector 22 may include a thermal neutron sensitive section 22A disposed closer to the exterior of the housing 12, and an epithermal neutron sensitive section 22B disposed interior to the thermal neutron sensitive section 22A. In the present example, a thermal neutron filter 22C, such as cadmium foil, may be disposed between the thermal neutron sensitive section 22A and the epithermal neutron sensitive section 22B to substantially prevent entry of thermal neutrons into the epithermal neutron sensitive section 22B of the combination detector. The combination detector 22 shown in FIG. 3B uses both the principle of “self-shielding” and neutron energy filtering to obtain a single detector that is separately sensitive to both thermal neutrons and epithermal neutrons.

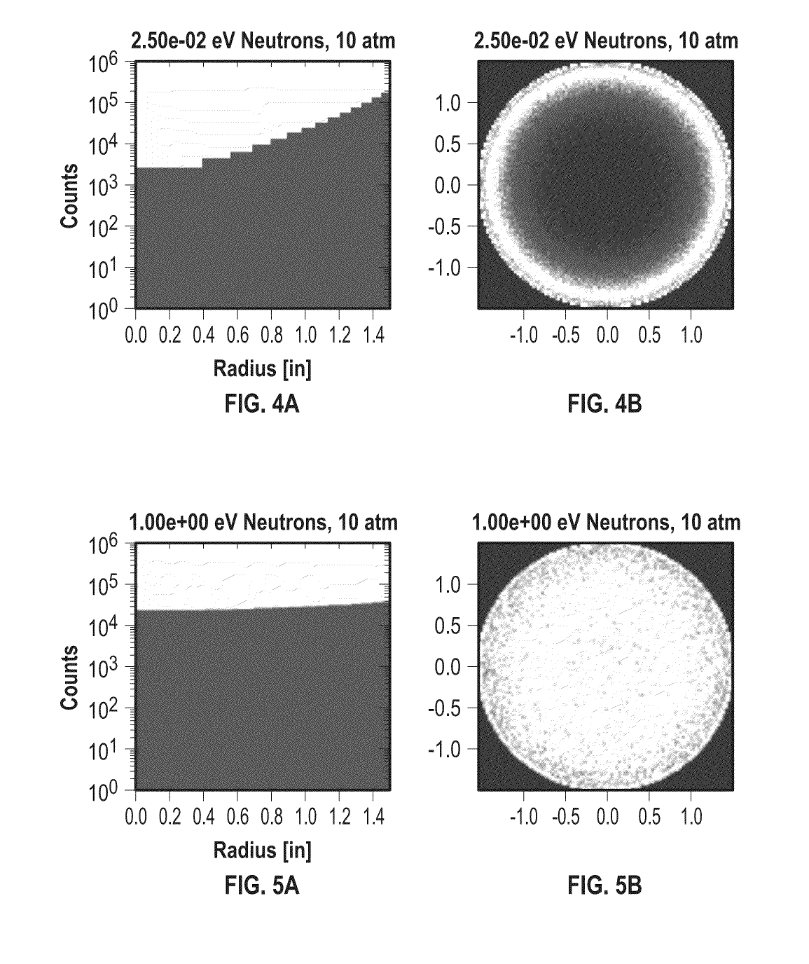

As an example of the self-shielding effect, first consider a conventional cylindrical helium-3 proportional neutron detector. A Monte-Carlo simulation of thermal neutrons (0.025 eV energy) incident on a 3 inch diameter helium-3 tube with a 10 atm pressure may be used to demonstrate the principle of self-absorption. FIG. 4A illustrates the simulated spatial distribution of neutron detection events in such a detector for incident omnidirectional thermal neutrons in graph form. In FIG. 4A the radius gives the distance from the center of the tube, and therefore the distance from the anode wire, and 1.5 inches is the position of the radial edge of the tube, and thus the position of the cathode. FIG. 4B shows a three dimensional histogram of the thermal neutron detection events simulated in the graph shown in FIG. 4A but for an entire cross-section of the helium-3 detector tube. It is evident from both the graph in FIG. 4A and the histogram in FIG. 4B that neutron detection occurs primarily near the exterior surface of the detector tube. Moving inwardly toward the center of the detector tube, the neutron detection density (that is after correcting for volume changes) decreases approximately exponentially by the exterior-proximate neutron detection and relatively fewer detections occur at smaller radii from the center of the detector tube.

On the other hand, for incident neutrons at epithermal energies (approximately 1 eV) as shown in a corresponding graph and histogram in FIGS. 5A and 5B, respectively, the self-shielding effect is substantially reduced. Although the neutron detection density is still higher near the exterior surface of the detector tube for epithermal neutrons than for thermal neutrons, neutron detection density is much less sensitive to depth from the exterior surface of the detector tube as will be apparent from viewing FIGS. 5A and 5B. Note that a conventional helium-3 detector tube has only a single anode and no segmentation, so while modeling may be used to observe the spatial variation in detection, the detector itself as conventionally made is not spatially sensitive with respect to the position of neutron detection within the detector tube.

There are various ways to form a segmented neutron detector to give thermal vs. epi-thermal discrimination, that is, a combination detector for this invention. As illustrative examples, a combination detector can be formed by bundling many slim 3He tubes with small diameters (as straws), or BCS, or stacking many solid-state devices in small sizes, or the disclosed CPC concept in this invention. In the following, similar modeling results can be shown when using a CPC still in a cylindrical design as illustrative and assuming the CPC constructed with 1 μm boron-10 layers and 1 mm separation at more than 5 atmospheres gas pressure.

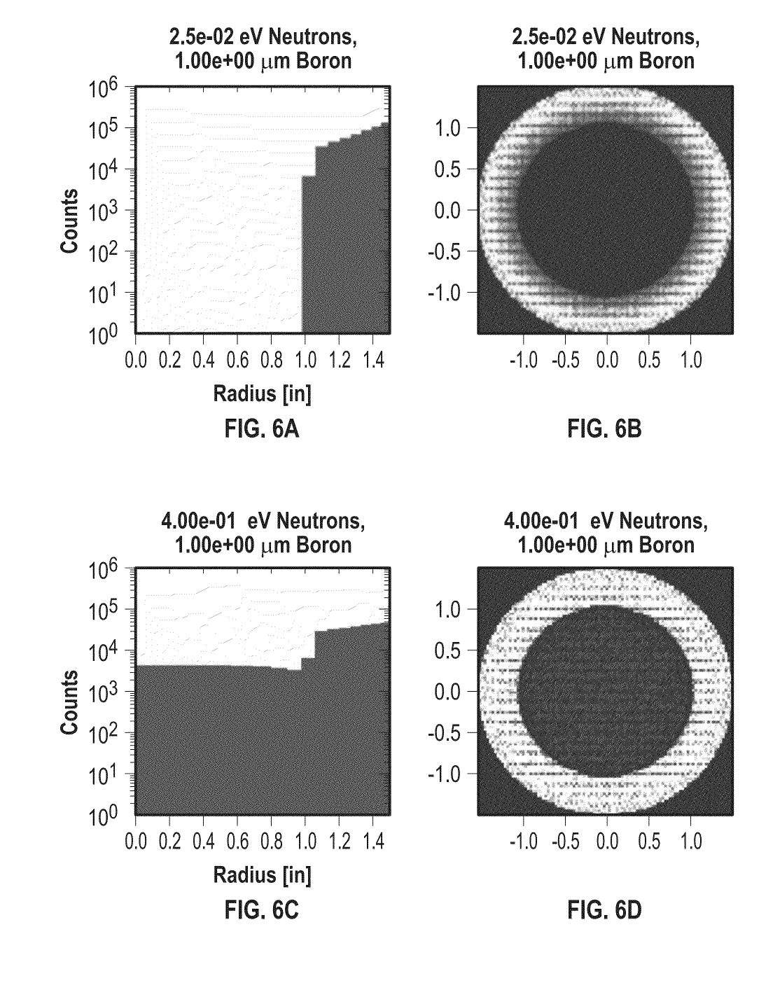

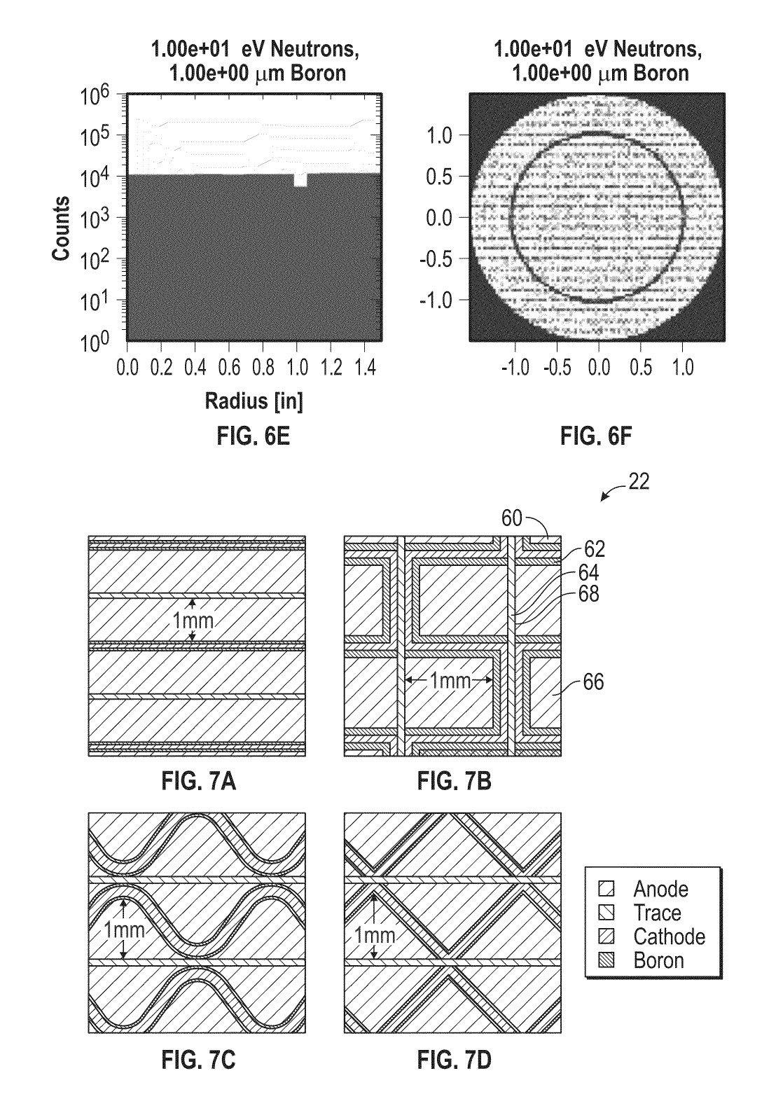

FIGS. 6A and 6B show, respectively, a graph with respect to distance from a center of the CPC detector tube, and three dimensional histogram of a cross section of the CPC detector tube of detection events wherein the CPC detector tube has disposed therein at a radial distance of one inch from the center thereof a 0.004 inch thick cadmium foil filter (e.g., 22C in FIG. 3B). FIGS. 6A and 6B are for neutrons having 0.025 eV energy entering the CPC detector tube.

FIGS. 6C and 6D show, respectively, modeled distribution of neutron detection locations for neutron energy at the low end of the epithermal range (about 0.4 eV) for the CPC detector with integrated cadmium filter of one inch radius as in FIGS. 6A and 6B as a graph and histogram. FIGS. 6E and 6F show a similar graph and histogram, respectively, for modeled (simulated) distribution of neutron detection locations for neutron energy at the high end of the epithermal range (about 10 eV) for a CPC detector with integrated cadmium filter of one inch radius as described with reference to FIGS. 6A and 6B.

FIGS. 7A through 7D show various configurations of a compact proportional counter (CPC) including various shapes for the cathode 60, covered in a thermal neutron absorptive layer 62 such as boron-10 carbide, a printed circuit board 64 with anode traces 68 spaced about 1 mm from the cathode 60, and various chambers 66 filled with detection gas such as argon mixed with methane, or any other combination of gases normally required in a proportional counter. In these examples boron-10 carbide is deposited with a thickness of 1 to 2 μm on both sides of each cathode. The cathodes may then be left in a “planar” configuration (FIG. 7A), or they may be formed in undulating patterns with a “square-wave” (FIG. 7B), “sinusoidal or corrugated” (FIG. 7C), and “saw-tooth or zigzag” (FIG. 7D) cross section. The stacked cathodes and anodes may be assembled in a cylindrical configuration with a relatively large diameter (1″-3″) and placed inside a pressure vessel containing fill gas at 5-10 atmospheres pressure.

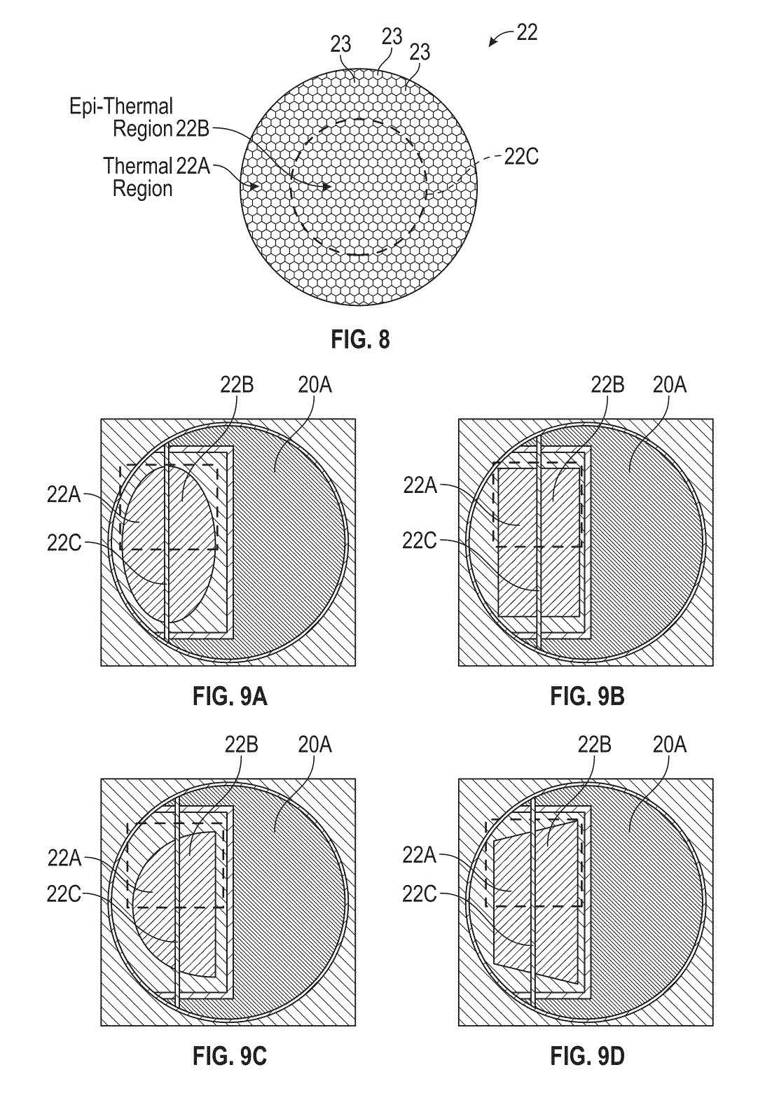

FIG. 8 shows one possible configuration of a combination detector using a plurality of individual detector elements. For example, the detector shown in FIG. 8 may comprise a plurality of boron coated straws as described in the Background section herein. Another possible configuration is a plurality of the CPC devices explained with reference to FIGS. 7A through 7D. The individual detector elements are shown at 23. In FIG. 8, the detector elements 23 may be arranged in a closest-packed substantially cylindrical form. A thermal neutron sensitive detection region is shown at 22A and is generally on the exterior of the combination detector 22. An epithermal neutron sensitive detection region 22B is shown generally on the interior of the detector 22. Irrespective of the type of detector elements used, whether BCS, CPC or solid state devices (e.g., silicon, silicon carbide, or diamond detectors embedded with ⁶Li or ¹⁰B converting materials), the anodes of the detecting elements 23 in each of the thermal neutron sensitive region 22A and the epithermal neutron sensitive region 22B may be electrically connected together so that an output signal corresponding to detection of thermal neutrons may be provided at one terminal, and an output signal corresponding to detection of epithermal neutrons may be provided at another terminal.

FIGS. 9A through 9D show various configurations of combination neutron detector for use in well logging instruments having selected directional sensitivity to neutrons entering the instrument. The shape of the combination detector 22, the relative thicknesses and shapes of the thermal neutron sensitive section 22A and the epithermal neutron sensitive section 22B, and the position of the thermal neutron filter 22C can be tailored or optimized for directional neutrons coming from the formation side of interests placed eccentrically in a tool for the best performance. In each case, directional sensitivity is provided by shielding the back (with respect to the formation) of the combination detector 22 with a neutron absorber 20A, e.g., in the form of boron carbide, or other high neutron capture cross section material so that neutrons enter the instrument for detection from a selected circumferential direction. Table 1 shows two commonly used types of neutron source, measurements that may be made using one or more combination detectors according to the present disclosure and possible well log parameters that can be determined therefrom.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A combined thermal neutron and epithermal neutron radiation detector, comprising:
a plurality of neutron detecting elements arranged such that a first set of the detecting elements are disposed closer to a source of neutron flux scattered from a material to be analyzed than a second set of neutron detecting elements, the neutron detecting elements having a material therein susceptible to capture of thermal neutrons; and
wherein signal outputs of the first set of neutron detecting elements are interconnected and signal outputs of the second set of neutron detecting elements are separately interconnected to provide a signal output corresponding to each of thermal neutron flux and epithermal neutron flux entering the combination detector.

2. The detector of claim 1 wherein the neutron detecting elements comprise ³He filled tubes or straws.

3. The detector of claim 1 wherein the neutron detecting elements comprise boron coated straws.

4. The detector of claim 1 wherein the neutron detecting elements comprise compact proportional counters.

5. The detector of claim 1 wherein the neutron detecting elements comprise solid state devices embedded with neutron converting material.

6. The detector of claim 5 wherein the solid state material comprises lithium-6.

7. The detector of claim 1 further comprising a thermal neutron filter disposed between the first set and the second set of detecting elements.

8. The detector of claim 7 wherein the thermal neutron filter comprises a neutron absorbing metal foil.

9. The detector of claim 8 wherein the metal foil comprises cadmium.

10. The detector of claim 1 wherein the first set of detecting elements comprises an annular ring disposed about a cylinder forming the second set of detecting elements.

11. The detector of claim 1 wherein the first set of detecting elements comprises a first selected shape disposed proximate a wall of a wellbore logging instrument housing and the second set of detecting elements comprises a second selected shape disposed internally from the wall with respect to the first set of detecting elements.

12. The detector of claim 1 wherein an interior of the instrument housing opposite the first set of detecting elements comprises a neutron absorbing material.

13. The detector of claim 12 wherein the neutron absorbing material comprises at least one of boron-10 and boron-10 carbide.

14. A method for analyzing neutron interaction properties of a material comprising:
irradiating the material with neutrons having energy level of at least one million electron volts;
detecting neutrons scattered from the material at a plurality of laterally spaced apart locations and at a single axial distance from a place of the irradiating, the plurality of locations separated into a first set of locations closer to the material than a second set of locations, and wherein the detecting comprises passing scattered neutrons through a thermal neutron absorbing material; and
summing the detected neutrons from the first set of locations into a first signal indicative of thermal neutron flux and summing the detected neutrons from the second set of locations into a second, separate signal indicative of epithermal neutron flux.

15. The method of claim 14 further comprising filtering thermal neutrons from moving into the second set of locations.
